(19) United States
(12) Patent Application Publication
(10) Pub. No.: US 2021/0332936 A1
(43) Pub. Date: Oct. 28, 2021

(54) FIXING DEVICE FOR DISPLAY UNIT

(71) Applicant: Shenzhen Huanuo AV Technology Co. Ltd, Shenzhen (CN)

(72) Inventor: YAQI LYU, Shenzhen (CN)

(21) Appl. No.: 16/879,392

(22) Filed: May 20, 2020

(30) Foreign Application Priority Data
Apr. 26, 2020 (CN) 202010337707.7

(51) Int. Cl. F16M 11/12; F16M 11/04; F16M 11/18; F16M 13/02

(52) U.S. Cl. CPC F16M 11/12; F16M 11/045; F16M 2200/066; F16M 13/022; F16M 2200/063; F16M 11/18

(57) ABSTRACT

A fixing device for a display unit, including a fixing mechanism including at least two guide rods arranged in parallel and a support assembly configured to slidably connect to the at least two guide rods, respectively; and a mounting bracket, configured for mounting the display unit thereon; the support assembly comprises a support bracket and at least two rolling assemblies disposed between the support bracket and the at least two guide rods; the at least two guide rods being respectively provided with a guide rail configured for slidably connecting with the support assembly; and the support bracket comprises a support portion configured for connecting with the mounting bracket and at least two fixing portions respectively straddling on at least two fixing portions of the at least two guide rods, and the at least two rolling assemblies further respectively abut against the at least two fixing portions and the guide rails.

### CROSS-REFERENCE TO RELATED APPLICATIONS

The present application claims priority under 35 U.S.C. § 119 to Chinese Patent Application Serial No. 202010337707.7 filed on Apr. 26, 2020, the entire contents of which are incorporated herein by reference thereto.

### TECHNICAL FIELD

The present application relates to the technical field of display unit accessories, and more specifically to a fixing device for a display unit.

### BACKGROUND

Display units are input and output devices belonging to a computer. It is a display tool that displays certain electronic files on a screen through a specific transmission device and reflects them to the human eye. With the advent of the information age, computers and networks have almost become an important part of the work and life of people, especially young people. In order to obtain a better viewing experience or to avoid excessive strain on the body due to long-term use of the display unit at home or office, a display unit bracket was born; the display unit bracket gives a great convenience for working and living, which has been widely used in retail, entertainment, finance, medical, transportation and other fields; the products include single screen, dual screen, large format splicing screen and other categories.

The wall-mounted display unit in the prior art usually fixes the display unit bracket on the wall first, and then fixes the display unit onto the display unit bracket. The display unit bracket has a function of resetting a position of the display unit. However, it needs to adjust a plurality of fasteners for tightness, the structure is complex and it is difficult to adjust, which brings inconvenience to the user during use and affects the user experience.

### SUMMARY

An object of the present application is to provide a fixing device for a display unit, in order to solve technical problems in the art that the structure of the display unit bracket is complex, it needs to adjust a plurality of fasteners when the user resets the position of the display unit, and it is difficult to adjust, which brings inconvenient technical problems to users during use.

In order to solve above-mentioned object, the technical solution adopted by the present application is to provide a fixing device for a display unit, including:

a fixing mechanism including at least two guide rods arranged parallel to each other and a support assembly configured to slidably connect to the at least two guide rods, respectively; and a mounting bracket, configured for mounting the display unit thereon;

the support assembly includes a support bracket and at least two rolling assemblies disposed between the support bracket and the at least two guide rods; the at least two guide rods being respectively provided with guide rails configured for slidably connecting with the support assembly; and the support bracket includes a support portion configured for connecting with the mounting bracket and at least two fixing portions respectively straddling on at least two fixing portions of the at least two guide rods, and the at least two rolling assemblies respectively abut against the at least two fixing portions and the guide rails.

Further, the fixing device for a display unit further includes: a collapsible mechanism connected between the fixing bracket and the mounting bracket and configured to allow the mounting bracket moving relative to the fixing bracket; the collapsible mechanism includes a bracket connected with the mounting bracket and a collapsible assembly disposed between the support assembly and the bracket.

Further, the collapsible assembly includes at least two first arms configured to rotatably connect with the support assembly and a second arm configured to rotatably connect between two first arms adjacent to each other and configured to rotatably connect with the bracket.

Further, the support bracket and the bracket are respectively provided with first mounting portions configured for connecting with the collapsible assembly, an end of the first arm configured to connect with the support bracket and an end of the second arm configured to connect with the bracket are respectively provided with second mounting portions, and the collapsible assembly further includes a first fastener configured for connecting the first mounting portion with the second mounting portion.

Further, the collapsible mechanism further includes a rotation member disposed between the collapsible assembly and the bracket, and the bracket is rotatable relative to the collapsible assembly with the rotation member as a rotation pivot.

Further, the at least two rolling assemblies respectively comprise a roller holder and a plurality of rollers rotatably connected to the roller holder, the roller holder defines an outer surface configured to abut against the support bracket and an inner surface disposed opposite to the outer surface, and the plurality of rollers configured to abut against the guide rails being provided at the inner surface of the roller holder.

Further, the at least two guide rods located at opposite ends of the guide rail are respectively provided with a limiting member configured for limiting a movement distance of the at least two rolling assemblies on the guide rail.

Further, the mounting bracket includes a connection frame configured to fixedly connect with the bracket and two connecting rods configured to mount the display unit thereon, and the two connecting rods are disposed at opposite sides of the connection frame in parallel.

Further, the two connecting rods are respectively provided with a first connecting portion configured for connecting to the connection frame, the first connecting portion includes an engaging groove configured for a part of the connection frame placing therein and a second fastener configured for limiting a movement of the connection frame relative to the two connecting rods, and sidewalls of the two connecting rods located in the engaging groove are respectively provided with a first connecting hole configured for the second fastener passing through and abut against the connection frame.

Further, the two connecting rods are respectively provided with a second connecting portion configured for connecting with the display unit, and the fixing device for the display unit further includes a third fastener configured for respectively connecting with the two connecting rods and the display unit, and the second connecting portion is provided with a second connecting hole configured for the third fastener passing through and fixedly connecting with the display unit.

Compared with the prior art, the beneficial effects of the fixing device for the display unit provided by the present application are that, the fixing device for the display unit of the present application fixes the display unit to the mounting bracket by mounting the fixing mechanism onto the wallboard, the fixing mechanism includes at least two guide rods arranged parallel to each other and a support assembly slidably connected to the at least two guide rods respectively, the support assembly includes a support bracket and at least two rolling assemblies disposed between the support bracket and the at least two guide rods, the at least two guide rods are provided with guide rails for slidably connecting with the support assembly, so that the support assembly is guided by the guide rails to slide on the guide rails; the support bracket includes a support portion for connecting to the mounting bracket and at least two fixing portions respectively straddling on the at least two guide rods, at least two rolling assemblies respectively abut against the at least two fixing portions and the guide rails, and the mounting bracket on which the display unit is mounted is fixedly connected to the support assembly, such that the display unit can be moved relative to the wallboard under the guidance of the guide rails, the structure is simple and stable, the position of the display unit can be adjusted under the action of the guide rods, the at least two rolling assemblies can be used to reduce the friction during sliding, such that the sliding on the guide rods can be more smooth and stable, thereby, it is easily and quickly for the user to reset the position of the display unit, and the user experience is effectively improved.

### BRIEF DESCRIPTION OF THE DRAWINGS

In order to explain the embodiments of the present application more clearly, a brief introduction regarding the accompanying drawings that need to be used for describing the embodiments of the present application or the prior art is given below; it is obvious that the accompanying drawings described as follows are only some embodiments of the present application, for those skilled in the art, other drawings can also be obtained according to the current drawings on the premise of paying no creative labor.

FIG. 1 is a schematic view of perspective structure of a fixing device for a display unit provided by an embodiment of the present application;

FIG. 2 is a schematic view of explosion structure of a fixing device for a display unit provided by an embodiment of the present application;

FIG. 3 is a schematic view of explosion structure of a rolling assembly of a fixing device for a display unit provided by an embodiment of the present application;

FIG. 4 is a schematic view of explosion structure of a mounting bracket of a fixing device for a display unit provided by an embodiment of the present application;

FIG. 5 is a schematic view of perspective structure of a fixing device for a display unit provided by another embodiment of the present application;

In the drawings, like numerals indicate corresponding parts throughout the several views;
1—fixing mechanism; 11—guide rod; 111—guide rail; 112—limiting member; 12—support assembly; 121—support bracket; 1211—support portion; 1212—fixing portion; 1213—first mounting portion; 122—rolling assembly; 121—roller holder; 1222—roller;
2—mounting bracket; 21—connection frame; 22—connecting rod; 221—first connecting portion; 2211—engaging groove; 2212—second fastener; 222—second connecting portion; and
3—collapsible mechanism; 31—bracket; 32—collapsible assembly; 321—first arm; 322—second arm; 323—first fastener; 324—second mounting portion; 33—rotation member.

### DETAILED DESCRIPTION

In order to make the technical problems, technical solutions and beneficial effects to be solved by the present application more clear, the present application will be further described in detail below in conjunction with the drawings and embodiments. It should be understood that the specific embodiments described herein are only used to explain the present application, and are not intended to limit the present application.

It is noted that when a component is referred to as being “fixed to” or “disposed on” another component, it can be directly or indirectly on another component. When a component is referred to as being “connected to” another component, it can be directly or indirectly connected to another component.

In the description of the present application, it needs to be understood that, directions or location relationships indicated by terms such as “length”, “width”, “up”, “down”, “front”, “rear”, “left”, “right”, “vertical”, “horizontal”, “top”, “bottom”, “inside”, “outside”, and so on are the directions or location relationships shown in the accompanying figures, which are only intended to describe the present application conveniently and simplify the description, but not to indicate or imply that an indicated device or component must have specific locations or be constructed and manipulated according to specific locations; therefore, these terms shouldn't be considered as any limitation to the present application.

It should be understood that the terms “first”, “second”, and “third” in the embodiments of the present application are for descriptive purposes only, and cannot be understood as indicating or implying relative importance or implicitly indicating the indicated the number of technical features. Thus, features defined as “first”, “second”, and “third” may explicitly or implicitly include one or more of the features.

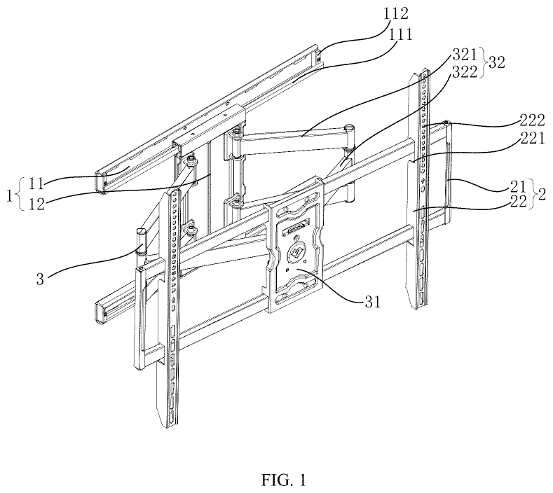

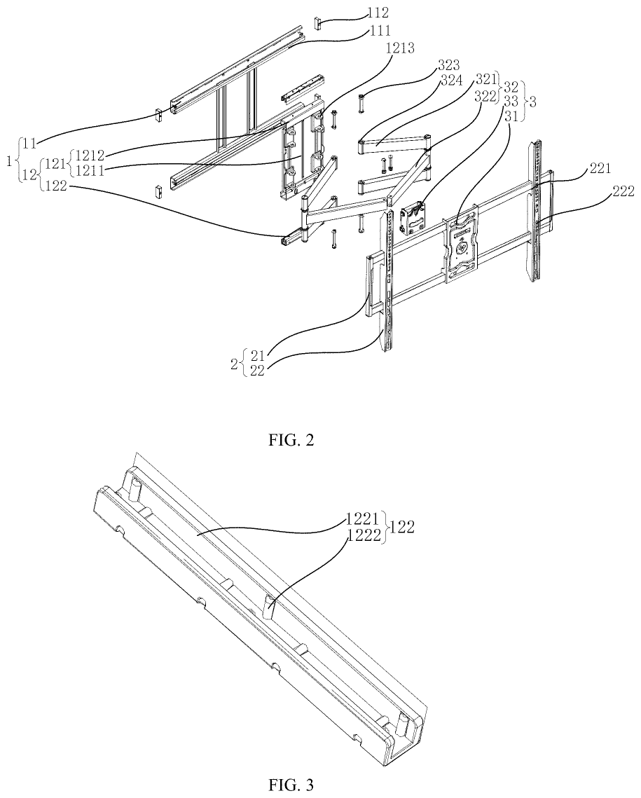

Please refer to FIG. 1 and FIG. 2 together, the present embodiment provides a fixing device for a display unit, including a fixing mechanism 1 and a mounting bracket 2 configured for mounting the display unit thereon; the fixing mechanism 1 includes at least two guide rods 11 and a support assembly 12 that are slidably connected to the at least two guide rods 11 respectively, the support assembly 12 includes a support bracket 121, and at least two rolling assemblies 122 that are disposed between the support bracket 121 and the at least two guide rods 11; the at least two guide rods 11 are respectively provided with a guide rail 111 configured for slidably connecting to the support assembly 12; the support bracket 121 includes a support portion 1211 configured for connecting with the mounting bracket 2 and at least two fixing portions 1212 respectively straddling on the at least two guide rods 11, and at least two rolling assemblies 122 are abutted against the at least two fixing portions 1212 and the guide rails 111, respectively.

The above-mentioned fixing device for the display unit, by fixing the display unit to the mounting bracket 2 by mounting the fixing mechanism 1 onto the wallboard, the fixing mechanism 1 includes at least two guide rods 11 arranged parallel to each other and a support assembly 12 slidably connected to the at least two guide rods 11 respectively, the support assembly 12 includes a support bracket 121 and at least two rolling assemblies 122 disposed between the support bracket 121 and the at least two guide rods 11, the at least two guide rods 11 are provided with guide rails 111 for slidably connecting with the support assembly 12, so that the support assembly 12 is guided by the guide rails 111 to slide on the guide rails 111; the support bracket 121 includes a support portion 1211 for connecting to the mounting bracket 2 and at least two fixing portions 1212 respectively straddling on the at least two guide rods 11, the at least two rolling assemblies 122 are respectively abut against the at least two fixing portions 1212 and the guide rails 111, and the mounting bracket 2 on which the display unit is mounted is fixedly connected to the support assembly 12, such that the display unit can be moved relative to the wallboard under the guidance of the guide rails 111, the structure is simple and stable, the position of the display unit can be adjusted under the action of the guide rods 11, the at least two rolling assemblies 122 can be used to reduce the friction during sliding, such that the sliding on the guide rods 111 can be more smooth and stable, thereby, it is easily and quickly for the user to reset the position of the display unit, and the user experience is effectively improved.

Please refer to FIG. 1 and FIG. 2 together. In this embodiment, the fixing device for the display unit is mounted on the wallboard, and the display unit is fixed on the fixing device for the display unit, such that the resetting of the position of the display unit can be achieved according to the requirement of the user. The fixing device for the display unit includes a fixing mechanism 1 fixedly connected to the wallboard and a mounting bracket 2 that is slidably connected to the fixing mechanism 1 and configured to mount the display unit thereon, and the specific structures of the fixing mechanism 1 and the mounting bracket 2 are not limited herein. The fixing mechanism 1 includes at least two guide rods 11 arranged parallel to each other and a support assembly 12 which is slidably connected to the at least two guide rods 11, respectively and configured to connect the mounting bracket 2 thereon, such that the support assembly 12 connected with the mounting bracket 2 can slide in an extending direction of the at least two guide rods 11 and realizes that the display unit moves relative to the wallboard parallel to the extending direction of the guide rod 11. The support assembly 12 includes a support bracket 121 and at least two rolling assemblies 122 disposed between the support bracket 121 and the at least two guide rods 11, the at least two rolling assemblies 122 respectively abut against the support bracket 121 and the at least two guide rods 11, and the specific structures of the support bracket 121 and rolling assembly 122 are not limited herein. The at least two guide rods 11 are respectively provided with a guide rail 111 for slidably connecting with the support assembly 12; the support bracket 121 includes a support portion for connecting the mounting bracket 1211 and at least two fixing portions 1212 respectively straddling on the at least two guide rods 11, and the at least two rolling assembly 122 are respectively abut against the at least two fixing portions 1212 and guide rail 111; the mounting bracket 2 on which the display unit is mounted is fixedly connected to the support assembly 12 such that the display unit can move relative to the wallboard under the guidance of the guide rail 111, the structure is simple and stable, and the position of the display unit is adjusted under the action of the guide rod 11. The using of at least two rolling assemblies 122 reduces the friction during sliding such that the sliding on the guide rod 11 can be more smooth and stable, and the user can reset the position of the display unit easily and quickly, and the user experience can be effectively improved. Preferably, the at least two guide rods 11 located at opposite ends of the guide rail 111 are provided with limiting members 112 to limit the movement distance of the at least two rolling assembly 122 on the guide rail 111 to prevent the support assembly 12 from disengaging from the guide rod 11 during sliding, which may cause damage to the display unit, the reliability and practicality of the fixing device for the display unit can be effectively improved.

Referring to FIG. 3, in this embodiment, at least two rolling assembly 122 of the fixing device for the display unit includes a roller holder 1221 and a plurality of rollers 1222 that are rotationally connected to the roller holder 1221. The specifics and material of the roller holder 1221 are not limited herein. Further, the roller holder 1221 includes abutment portions that respectively abut against the fixing portion 1212 and the guide rail 111, and limiting portions disposed at opposite ends of the abutment portion and configured for limiting the movement of the fixing portion 1212 relative to the roller holder 1221 in a direction parallel to the extending direction of the guide rod 11. The abutment portion of the roller holder 1221 effectively increases the contact surface between the roller holder 1221 and the guide rod 11, such that the sliding on the guide rod 11 is more smooth and stable, by providing limiting portions on opposite sides of the abutment portion for limiting the movement of the fixing portion 1212 relative to the roller holder 1221 in a direction parallel to the extension direction of the guide rod 11, which prevents the support assembly 12 from disengaging from the roller holder 1221 when the display unit is pushed to control the collapsible mechanism 3 sliding on the guide rod 11, the reliability of the fixing device for the display unit is effectively improved. Further preferably, the roller holder 1221 is a polyacetal sliding seat, which has high strength, high rigidity, good elasticity, smooth surface, and wear resistance such that the connection between the support assembly 12 and the guide rod llmore stable, the contact area is larger, and the support bracket 121 slides on the guide rod 11 more smooth and stable. Further, the roller holder 1221 has an outer surface abutting the support bracket 121 and an inner surface opposite to the outer surface. A plurality of rollers 1222 are evenly arranged at inner surface of the roller holder 1221, and a number of the rollers 1222 are not limited herein. By fixedly connecting of roller holder 1221 of the rolling assembly 122 with the support bracket 121, and using the plurality of rollers 1222 to slide on the guide rail 111, to reduce the friction between the support assembly 12 and the guide rod 11 during the sliding, such that the sliding on the guide rod 11 is more smooth and stable. Three sidewalls of the roller holder 1221 that are abutted against the guide rail 111 are evenly provided with at least two rollers 1222, respectively, while ensuring smooth and stable sliding on the support assembly 12 and the guide rod 11, it is more effective to reduce the friction between the support bracket 121 and the guide rail 111 during the sliding, such that the user is more labor-saving when resetting the position of the display unit to improve user experience.

Please refer to FIGS. 1 and 2 together. In the embodiment, the fixing device for the display unit further includes a collapsible mechanism 3 connected between the fixing bracket and the mounting bracket 2 and capable of moving the mounting bracket 2 relative to the fixing bracket, and the specific structure of the collapsible mechanism 3 is not limited herein. Further, the collapsible mechanism 3 includes a bracket 31 connected to the mounting bracket 2 and a collapsible assembly 32 provided between the support assembly 12 and the bracket 31, and the mounting bracket 2 can be pushed to move relative to the fixing mechanism 1 by an external force and driving the collapsible assembly 32 to fold and unfold, such that the display unit can be controlled to move away from or close to the wallboard, the specific structures of the bracket 31 and the collapsible assembly 32 are not limited herein. The collapsible assembly 32 includes at least two first arms 321 that are rotatably connected to the support assembly 12, and a second arm 322 that is rotatably connected between the two adjacent first arms 321 and that is rotatably connected to the bracket 31, by providing the at least two first arms 321 and the second arm 322 arranged between two adjacent first arms 321, which increases the adjustable of the distance away from the wall of the collapsible mechanism 3, the requirement of the user is satisfied, and the practicality of the fixing device for the display unit is effectively improved. Both the support bracket 121 and the bracket 31 are respectively provided with a first mounting portion 1213 configured for connecting with the collapsible assembly 32, an end of the first arm 321 connected with the support bracket 121 and an end of the second arm 322 connected with the bracket 31 are respectively provided with a second mounting portion 324, the collapsible mechanism 3 further includes a first fastener 323 configured for connecting the first mounting portion 1213 with the second mounting portion 324, and the first mounting portion 1213 and the second mounting portion 324 are connected through the first fastener 323 such that one end of the first arm 321 is firmly connected to the support bracket 121, and the other end is rotatably connected to the second arm 322, one end of the second arm 322 is firmly connected to the bracket 31, and the other end is rotatably connected to the first arm 321, which is convenient for disassembly and assembly, and convenient for transportation and user installation. Further preferably, the collapsible mechanism 3 further includes a rotation member 33 disposed between the collapsible assembly 32 and the bracket 31, and the bracket 31 can rotate relative to the collapsible assembly 32 with the rotation member 33 as the center of rotation, by arranging the rotation member 33 between the collapsible assembly 32 and the bracket 31 such that the fixing device for the display unit can not only satisfy the adjustment in the extension direction parallel to the guide rod 11 and the adjustment of the distance away from the wall, but also can adjust the angle of the display direction of the display unit, the practicality of the fixing device for the display unit is effectively improved to meet the requirement of the user.

Please further refer to FIG. 1 and FIG. 2. In this embodiment, the mounting bracket 2 for the fixing device of the display unit includes a connection frame 21 fixedly connected to the bracket 31 and two connecting rods 22 configured for mounting the display unit thereon. The connecting rods 22 are arranged parallel to each other on opposite sides of the connection frame 21, such that the display unit can be firmly mounted on the mounting bracket 2, the specific structures of the connection frame 21 and connecting rod 22 are not limited herein; the user can directly apply force to the display unit, and the connection frame 21 fixedly connected to the connecting rod 22 can then transmit the force to the collapsible mechanism 3 and the support assembly 12 to reset the position of the display unit.

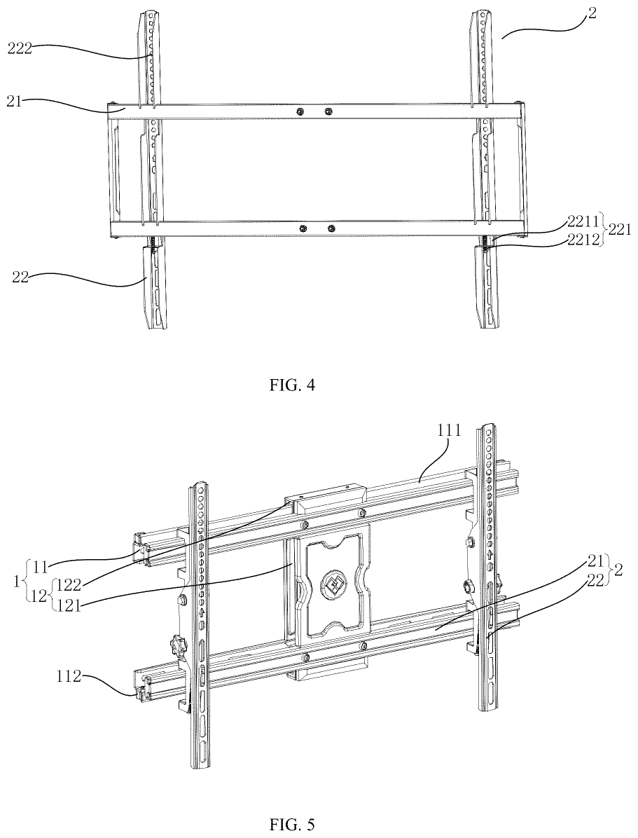

Referring to FIG. 4, in this embodiment, the two connecting rods 22 of the mounting bracket 2 for the fixing device of the display unit are respectively provided with a first connecting portion 221 configured for connecting to the connection frame 21, and the specific structure of the first connecting portion 221 is not limited herein. The first connecting portion 221 includes an engaging groove 2211 configured for placing the connection frame 21 therein and a second fastener 2212 for limiting the movement of the connection frame 21 relative to the two connecting rods 22. The sidewalls of the two connecting rods 22 that are located in the engaging groove 2211 are respectively provided with a first connection hole configured for the second fastener 2212 to penetrate and abut the connection frame 21, a part of the connection frame 21 is firstly placed into the engaging groove 2211 of the connecting rods 22, such that the connecting rods 22 are fixed to the connection frame 21, then the second fastener 2212 passes through the first connecting hole to be fixed to the connection frame in the engaging groove 2211, which is convenient for disassembling and assembling. Both connecting rods 22 are respectively provided with a second connecting portion 2212 for connecting to the display unit, the specific structure of the second connecting portion 2212 is not limited herein, and the fixing device for the display unit further includes a third fastener configured for respectively connecting with two connecting rods 22 and the display unit, the second connecting portion 2212 is provided with a second connection hole through which the third fastener penetrates and is fixedly connected to the display unit, a number of the second connection hole is multiple, which not only can stabilize the display unit being mounted onto the fixing device for the display unit, and by providing a plurality of second connection holes, it is suitable for display units of various sizes, increasing the scope of application of the fixing device for the display unit.

Referring to FIG. 5, as another embodiment of the present application, a fixing device for a display unit includes a fixing mechanism 1 and a mounting bracket 2 for mounting the display unit thereon. The fixing mechanism 1 includes at least two guide rods 11 and a support assembly 12 slidably connected to the at least two guide rods 11 respectively, the support assembly 12 includes a support bracket 121 and at least two rolling assemblies 122 disposed between the support bracket 121 and the at least two guide rods 11; the at least two guide rods 11 are respectively provided with a guide rail 111 for slidably connecting with the support assembly 12; the at least two rolling assemblies 122 abut against the support bracket 121 and the guide rail 111, respectively.

The above-mentioned fixing device for the display unit, by fixing the display unit to the mounting bracket 2 by mounting the fixing mechanism 1 onto the wallboard, the fixing mechanism 1 includes at least two guide rods 11 arranged parallel to each other and a support assembly 12 slidably connected to the at least two guide rods 11 respectively, the support assembly 12 includes a support bracket 121 and at least two rolling assemblies 122 disposed between the support bracket 121 and the at least two guide rods 11, the at least two guide rods 11 are provided with guide rails 111 for slidably connecting with the support assembly 12, so that the support assembly 12 is guided by the guide rails 111 to slide on the guide rails 111; the at least two rolling assemblies 122 respectively abut against the at least two fixing portions 1212 and the guide rails 111, and the mounting bracket 2 on which the display unit is mounted is fixedly connected to the support assembly 12, such that the display unit can be moved relative to the wallboard under the guidance of the guide rails 111, the structure is simple and stable, the position of the display unit can be adjusted under the action of the guide rods 11, the at least two rolling assemblies 122 can be used to reduce the friction during sliding, such that the sliding on the guide rods 111 can be more smooth and stable, thereby, it is easily and quickly for the user to reset the position of the display unit, and the user experience is effectively improved.

The above is only the preferred embodiments of this application, and is not intended to limit the present application. Any modification, equivalent replacement and improvement made within the spirit and principle of this embodiment should be included within the protection scope of the embodiment.

1. A fixing device for a display unit, comprising:
a fixing mechanism, comprising two guide rods arranged parallel to each other and a support assembly configured to slidably connect with the two guide rods, respectively; and
a mounting bracket, configured for mounting the display unit thereon;
wherein the support assembly comprises a support bracket and two rolling assemblies disposed between the support bracket and the two guide rods; the two guide rods being respectively provided with guide rails configured for slidably connecting with the support assembly; and
wherein the support bracket comprises a support portion configured for connecting with the mounting bracket and two fixing portions respectively straddling on two fixing portions of the two guide rods, and the two rolling assemblies respectively abut against the two fixing portions and the guide rails;
wherein the fixing device for the display unit further comprises: a collapsible mechanism connected between the fixing bracket and the mounting bracket and configured to allow the mounting bracket movable relative to the fixing bracket the collapsible mechanism comprises a bracket connected with the mounting bracket and a collapsible assembly disposed between the support assembly and the bracket;
wherein the collapsible mechanism further comprises a rotation member disposed between the collapsible assembly and the bracket, and the bracket is rotatable relative to the collapsible assembly with the rotation member as a rotation pivot; and
wherein the two rolling assemblies respectively comprise a roller holder and a plurality of rollers rotatably connected to the roller holder, the roller holder defines an outer surface configured to abut against the support bracket and an inner surface disposed opposite to the outer surface, and the plurality of rollers in a linear arrangement configured to abut against the guide rails being provided at the inner surface of the roller holder.

2. (canceled)

3. The fixing device for a display unit of claim 1, wherein the collapsible assembly comprises: two first arms configured to rotatably connect with the support assembly and a second arm configured to rotatably connect between two first arms adjacent to each other and configured to rotatably connect with the bracket.

4. The fixing device for a display unit of claim 3, wherein the support bracket and the bracket are respectively provided with first mounting portions configured for connecting with the collapsible assembly, an end of the first arm configured to connect with the support bracket and an end of the second arm configured to connect with the bracket are respectively provided with second mounting portions, and the collapsible assembly further comprises a first fastener configured for connecting the first mounting portion with the second mounting portion.

5.-6. (canceled)

7. The fixing device for a display unit of claim 1, wherein the two guide rods located at opposite ends of the guide rail are respectively provided with a limiting member configured for limiting a movement distance of the two rolling assemblies on the guide rail.

8. The fixing device for a display unit of claim 1, wherein the mounting bracket comprises: a connection frame configured to fixedly connect with the bracket and two connecting rods configured to mount the display unit thereon, and the two connecting rods are disposed at opposite sides of the connection frame in parallel.

9. The fixing device for a display unit of claim 8, wherein the two connecting rods are respectively provided with a first connecting portion configured for connecting to the connection frame, the first connecting portion comprises an engaging groove configured for a part of the connection frame placing therein and a second fastener configured for limiting a movement of the connection frame relative to the two connecting rods, and sidewalls of the two connecting rods located in the engaging groove are respectively provided with a first connecting hole configured for the second fastener passing through and abut against the connection frame.

10. The fixing device for a display unit of claim 8, wherein the two connecting rods are respectively provided with a second connecting portion configured for connecting with the display unit.
